(19) United States
(12) Patent Application Publication
(10) Pub. No.: US 2018/0073924 A1
(43) Pub. Date: Mar. 15, 2018

(54) OPTOELECTRONIC MODULE FOR SPECTRAL AND PROXIMITY DATA ACQUISITION

(71) Applicant: Heptagon Micro Optics Pte. Ltd., Singapore (SG)

(72) Inventors: Lukas Steinmann, Singapore (SG); Hartmut Rudmann, Jona (CH)

(73) Assignee: Heptagon Micro Optics Pte. Ltd., Singapore (SG)

(21) Appl. No.: 15/558,209

(22) PCT Filed: Feb. 12, 2016
(86) PCT No.: PCT/SG2016/050073

§ 371 Date: Sep. 14, 2017

Related U.S. Application Data
(60) Provisional application No. 62/135,268, filed on Mar. 19, 2015.

(51) Int. Cl. G01J 3/10; G01J 3/50

(52) U.S. Cl. CPC G01J 3/108; G01J 3/50

(57) ABSTRACT

Optoelectronic modules for proximity determination and ambient light sensing include hybrid optical assemblies configured with multiple field-of-views. The field of view in a region of the hybrid optical assembly can be dedicated to a first detector, while the field of views in another region of the hybrid optical assembly can be dedicated to both the emission of light and ambient light sensing. Embodiments relate particularly to implementation in a mobile phone or other portable electronic devices.

### TECHNICAL FIELD

The present disclosure relates to optoelectronic modules configured to acquire spectral and proximity data.

### BACKGROUND

The dimensions of optoelectronic modules implemented in mobile devices are subject to strict constraints. Moreover, various types of optoelectronic modules implemented in mobile devices may be used for various applications; such as, 2D imaging, 3D imaging, gesture recognitions, ambient light sensing/spectral data acquisition, and proximity/distance data acquisition. A challenge exists to reduce the footprint of optoelectronic modules, while incorporating a number of the aforementioned applications. An optoelectronic module with combined ambient-light sensing/spectral data acquisition and proximity data acquisition may exhibit a reduced footprint as both functions are executed by the same optoelectronic module.

### SUMMARY

This disclosure describes optoelectronic modules that acquire both ambient light/spectral data and proximity/distance data. Various implementations are described that employ a hybrid optical assembly for the acquisition of ambient light/spectral data and proximity/distance data.

In one aspect, this disclosure describes an optoelectronic module that includes a substrate on which are integrated a light source configured to emit light at a particular one or more wavelengths with respect to an emission axis. The optoelectronic module further includes a second detector configured to detect light at one or more wavelengths, and a first detector configured to detect light at one or more wavelengths. The optoelectronic module further includes a spacer structure laterally surrounding the light source, the second detector, and the first detector. The spacer structure is composed of a material that is non-transparent to the particular one or more wavelengths of light emitted by the light source or detectable by the second detector or first detector. The optoelectronic module further includes an inner wall that isolates the first detector from the light source. The inner wall is composed of a material that is non-transparent to the particular one or more wavelengths of light emitted by the light source or detectable by the second detector or the first detector. The optoelectronic module further includes a hybrid optical assembly that is laterally surrounded by the spacer structure. The hybrid optical assembly includes a first region with a first field-of-view and a first optical axis, a second region with a second field-of-view and a second optical axis, and a third region characterized by a third field-of-view and a third optical axis. The first region is aligned with the light source. The second region is aligned with the second detector, and the third region is aligned with the first detector.

In another aspect, this disclosure describes an optoelectronic module that further includes a first filter aligned with a first detector. The first filter is transparent to one or more wavelengths of light emitted by a light source. The optoelectronic module further includes a second filter aligned with a second detector. The second filter is non-transparent to the one or more wavelengths of light emitted by the light source.

In another aspect, this disclosure describes an optoelectronic module that further includes a baffle structure. The baffle structure is composed of a material that is non-transparent to a particular one or wavelengths of light emitted by a light source or detectable by a second detector or a first detector.

In another aspect, this disclosure describes an optoelectronic module that further includes a light source emission axis that is substantially perpendicular to a substrate.

In another aspect, this disclosure describes an optoelectronic module that further includes a first optical axis that is substantially perpendicular to a substrate.

In another aspect, this disclosure describes an optoelectronic module that further includes a light source emission axis that is substantially coaxial with a first optical axis.

In another aspect, this disclosure describes an optoelectronic module that further includes a first field-of-view that is between 10° and 20°.

In another aspect, this disclosure describes an optoelectronic module that further includes a first field-of-view that is between 5° and 10°.

In another aspect, this disclosure describes an optoelectronic module that further includes a first field-of-view that is between 1° and 3°.

In another aspect, this disclosure describes an optoelectronic module that further includes a second field-of-view that is between 60° and 180°.

In another aspect, this disclosure describes an optoelectronic module that further includes a light source that emits wavelengths corresponding to infrared light.

In another aspect, this disclosure describes an optoelectronic module that further includes a light source that is a vertical-cavity surface-emitting laser.

In another aspect, this disclosure describes an optoelectronic module that further includes a light source that is configured to emit modulated light.

In another aspect, this disclosure describes an optoelectronic module that further includes a hybrid optical assembly that is implemented as an overmold. The overmold encases a first and second detector and a light source.

In another aspect, this disclosure describes an optoelectronic module that further includes a third optical axis that is substantially perpendicular to a substrate.

In another aspect, this disclosure describes an optoelectronic module that further includes a third optical axis that is tilted with respect to a substrate. A field-of-view of a first region partially overlaps a field-of-view of a third region.

In another aspect, this disclosure describes an optoelectronic module that further includes a first field-of-view and a third field-of-view that overlap.

One or more of the features of the foregoing aspects may be included in some implementations. Other aspects, features and advantages will be readily apparent from the following detailed description, the accompanying drawings, and the claims.

### BRIEF DESCRIPTION OF THE DRAWINGS

FIG. 1 depicts a side view of an example implementation of an optoelectronic module for spectral and proximity data acquisition.

FIG. 2 depicts a side view of an example implementation of an optoelectronic module for spectral and proximity data acquisition operating in proximity sensing mode.

FIG. 3 depicts a side view of an example implementation of an optoelectronic module for spectral and proximity data acquisition operating in spectral sensing mode.

FIGS. 4A-D depict plan views of example implementations of hybrid optical assemblies with circular refractive optical regions.

FIG. 5 depicts a side view of another example implementation of an optoelectronic module for spectral and proximity data acquisition where a hybrid optical assembly is implemented as an overmold.

FIG. 6 depicts a side view of another example implementation of an optoelectronic module for spectral and proximity data acquisition where a region of the hybrid optical assembly is tilted.

### DETAILED DESCRIPTION

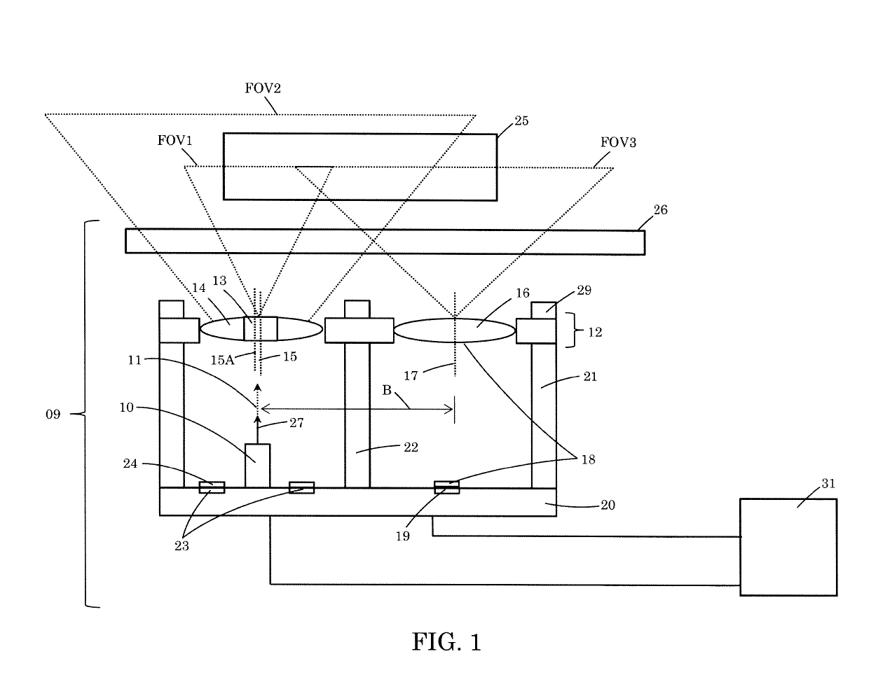

FIG. 1 depicts a side view of an example implementation of an optoelectronic module 09 for spectral and proximity data acquisition. The optoelectronic module 09 includes a light source 10 (e.g., a vertical-cavity surface-emitting laser (VCSEL) or light-emitting diode (LED)) that emits light 27; i.e., electromagnetic radiation with wavelengths corresponding to visible or non-visible light. In some cases (e.g., when employing a VCSEL) the electromagnetic radiation is emitted with minimal spatial divergence/full-field-of-view divergence; e.g., 5-25°, preferably <10°. In addition, or in other cases, the light source 10 can be collimated. Still further, the electromagnetic radiation can be emitted with minimal spectral divergence/spectral bandwidth; e.g., +/−10 nm or even less. The light source 10 may emit light 27 of non-visible wavelengths, such as infrared wavelengths; e.g., 850 nm or 940 nm. The light source 10 may emit light 27 that is substantially parallel to an emission axis 11. Still further the light source 10 can be configured to emit light 27 that is modulated.

The optoelectronic module 09 further includes a hybrid optical assembly 12; e.g., a hybrid lens, a series of lenses, an array of lenses, or a combination of lenses and transparent surfaces. The hybrid optical assembly 12 can include multiple optical regions such as a first region 13 and a second region 14. First region 13 is substantially transparent to radiation emitted by the light source 10. Further, a first optical axis 15 of first region 13 can be substantially coaxial with the emission axis 11. First region 13 in combination with the emission properties of the light source 10 (e.g., emission properties such as spatial divergence) can be characterized, for example, by a relatively narrow FOV in some cases; e.g., 10-20°, or 5-10° or even less 1-3°. The field-of-view of the first region 13 is an example of a first field-of-view FOV1. In some cases, first region 13 can be configured to reduce beam divergence of the emitted light 27; e.g., to 1-3°. The second region 14 can be substantially transparent to broad wavelength ranges of light (e.g., UV, visible, IR) and/or specific regions of visible or non-visible light (e.g., red, green, or UV). Further, the second region 14 is characterized by a second field-of-view FOV2. In some cases, the second field-of-view FOV2 can be wide with respect to the first field-of-view FOV1. For example, the second field-of-view FOV2 can be at least 60°, but it can be greater in other implementations; that is, in some implementation the filed-of-view FOV2 can be between 60° and 180°. The second region is further characterized by a second optical axis 15A. The second optical axis 15A is coaxial with the first optical axis 15 in FIG. 1 (although optical axis 15, 15A are depicted with a slight offset in FIG. 1). However, in other implementations, the first and second optical axes 15, 15A need not be coaxial. For example, the first and second optical axes 15, 15A can be parallel but not coaxial. Still, in other examples, the first and second optical axes 15, 15A may not be parallel but can be respectively tilted with respect to one another.

In the aforementioned example, the first region 13 and the second region 14 may not be optically distinct regions of the hybrid optical assembly 12. That is, the hybrid optical assembly 12 may include a transparent region with no optical function (e.g., no focusing power) such that the first region 13 and the second region 14 are not optically distinct regions. Thus, the first region 13 and the second region 14 need not be characterized by optically distinct regions of the hybrid optical assembly 12, but can in fact be characterized by optically indistinct regions of the hybrid optical assembly 12. In such implementations, the first field-of-view FOV1 can be defined by the spatial divergence of the light source 10. For example, if the spatial divergence of the light source 10 is 15°, then the field-of-view FOV1 is 15°.

The hybrid optical assembly 12 further includes a third region 16. The third region 16 is substantially transparent to radiation emitted by light source 10. Further, third region 16 can be configured to collect light 27 reflected from an object 25. Third region 16 is characterized by a field of view, i.e., a third field-of-view FOV3. For example, in some implementations, the third field-of-view FOV3 can be 25° or even less.

The third region 16 is further characterized by a third optical axis 17. The third optical axis 17 can be aligned with or intersect a first filter 18 that selectively allows a defined wavelength of light; e.g., an IR band-pass filter such as a dielectric band-pass filter, to pass through.

The optoelectronic module 09 further includes a first detector 19. First filter 18 can be positioned on either the object-side or detector-side surface of the third region 16, or in any other location between the third region 16 and the first detector 19. First filter 18 may transmit radiation emitted by light source 10 and may prevent the transmission of substantially all other visible and/or non-visible wavelengths (e.g., UV, VIS, IR). First detector 19 (e.g., a photodiode, a pixel, a demodulation pixel as used for time-of-flight applications, a pixel array such as a CMOS or CCD sensor array, and/or an array of demodulation pixels) is sensitive to—that is, may detect—at least a wavelengths or range of wavelengths of radiation emitted by light source 10. Further the first detector 19 and the light source 10 are separated by a baseline B. For example, the baseline B can be 2.4 mm or 2.5 mm. Still in other implementations the baseline can be larger, for example, up to 5 mm or even larger depending on the intended application of the optoelectronic module 09. The third region 16 may further be composed of a plurality of optical components such as diffractive and/or refractive lenses, apertures, stops, additional optical filters, and/or active (e.g., transformable) diffractive and/or refractive lenses. The light source 10 is electrically integrated with respect to a substrate 20; e.g., a PCB or silicon substrate. For example, the light source 10 can be electrically mounted on a PCB. In another example, the light source 10 can be integrated within a silicon substrate. Further, the first detector 19 is electrically integrated with respect to the substrate 20 (e.g., PCB or silicon). For example, the first detector 19 can be electrically mounted on a PCB. In another example, the first detector 19 can be integrated within a silicon substrate. The third region 16, the third field-of-view, and the first detector 19 are configured to acquire proximity data at various distances. For example, if the light source 10 is configured to emit modulated light, and the first detector 19 is composed of demodulation pixels, the proximity range of the optoelectronic module 09 can be from 10 cm to 30 cm or more. Still in other implementations, the proximity range can be from 0 mm to 50 mm. While still in other in other implementations, the proximity range can be from 0 mm to 30 cm or more.

The optoelectronic module 09 further includes a spacer structure 21 that is non-transparent to light. In particular spacer structure 21 is non-transparent to radiation emitted by the light source 10 and wavelengths detectable by the first detector 19 and a second detector 23(e.g., broad-spectrum white, UV, IR). Spacer structure 21 can be manufactured, for example, by vacuum injection molding from substantially non-transparent material such as an epoxy with a non-transparent filler material in some implementation. Alternatives spacer structures and/or alternative manufacturing methods (e.g., alternatives to vacuum injection molding) can be used in some cases. For example, the spacer structure can be composed of a substantially non-transparent wafer (e.g., a substantially non-transparent PCB) or a substantially non-transparent lead frame. The optoelectronic module 09 further includes a non-transparent inner wall 22 mounted on the substrate 20. The inner wall 22 is non-transparent to radiation emitted by the light source 10 and wavelengths detectable by first detector 19. Further the inner wall 22 isolates the light source 10 and the first detector 19 such that light emitted from the light source 10 is not directly incident on the first detector 19. That is, the non-transparent wall 22 is configured to prevent cross-talk between the light source 10 and the first detector 19.

The hybrid optical assembly 12 can be manufactured from polymeric material by, for example, replication, injection molding, vacuum injection molding, embossing, and/or imprinting. Alternatively, the hybrid optical assembly 12 can be manufactured from material with properties similar to a polymeric material (e.g., materials with similar optical, mechanical, or manufacturability properties). Further, the first region 13, the second region 14, and the third region 16 may be manufactured as part of a same laterally contiguous array of regions (e.g., array of lenses, or can be manufactured and placed individually onto/into spacer structure 21, for example, via a pick-and-place technique). Although only a single lens is depicted in FIG. 1 for each region within the hybrid optical assembly 12, each first, second and third may include multiple lens elements according to their respective function/optical performance. Further, in some cases the hybrid optical assembly 12 can be composed of a transmissive panel without additional lenses; e.g., of glass or other transparent material.

The second detector 23 can be, for example, a single photo-sensitive element or an array of photosensitive elements (e.g., a CMOS or CCD sensor array). Further, the second detector 23 can include one or more photosensitive elements with different spectral sensitivities. Further, the second detector 23 can be implemented as other photodiodes, such as buried double-junction photodiodes. The second detector 23 is electrically integrated with respect to a substrate 20 (e.g., PCB or silicon). For example, the second detector 23 can be electrically mounted on a PCB. In another example, the second detector 23 can be integrated within a silicon substrate. The second detector 23 is aligned with the second region 14; that is, light transmitted via the second region 14 can be substantially incident on the second detector 23. The optoelectronic module 09 further includes a second filter 24. The second filter 24 can be positioned over/aligned with the second detector 23. The second filter 24 can be non-transparent to wavelengths of light, such as IR, UV, and/or other regions of the visible or non-visible electromagnetic spectrum. In some cases the second filter 24 can substantially block radiation emitted by light source 10. Further, the second filter 24 can be positioned on the object-side surface or detector-side surface of second region 14 of the hybrid optical assembly 12. The second filter 24 may further be positioned between hybrid optical assembly 12 and the second detector 23 such that cross-talk or spurious reflections emanating from light source 10 can be blocked from impinging on the second detector 23 or are substantially reduced. The second detector 23 can be sensitive to a broad spectrum of light (e.g., UV, visible, IR). Alternatively, or in addition, the second detector 23 can be composed of a plurality of photosensitive components, where each can be sensitive to a different range of visible or non-visible light (e.g., such as red, green, blue or UV). Generally, the second filter 24 can be transmissive to wavelengths of visible or non-visible light that are not emitted by the light source 10. Further, the second detector 23 and the second filter 24 can be configured to collect ambient light. Still further, the second detector 23 and the second filter 24 can be configured to determine the spectral composition of ambient light. For example, the second filter 24 can comprise a color-filter array (CFA) such that light incident on the second filter 24 can be partitioned into spectral components, that is, signals corresponding to the different spectral components can be used to determine the spectral composition, color, intensity, or to determine the source of the ambient light; e.g., the sun, a sodium-vapor lamp, a fluorescent lamp, and/or an incandescent lamp.

Spacer structure 21 provides structural support for hybrid optical assembly 12, and further establishes a distance between the hybrid optical assembly 12 and the light source 10, the second detector 23 and the first detector 19. The spacer structure 21 can include features to customize the distance between the hybrid optical assembly 12 and the light source 10, the second detector 23 and the first detector 19.

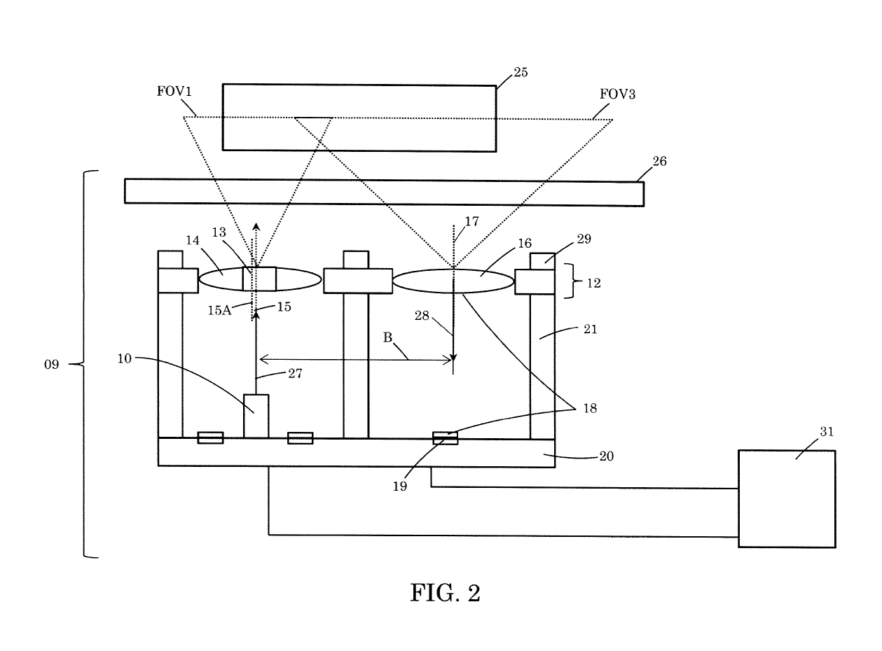

FIG. 2 depicts a side view of an example implementation of an optoelectronic module operating in a proximity sensing mode. An object 25 (e.g., a user of a host device containing module 09 or a user's appendage such as an ear) is positioned within the first field-of-view FOV1 and third field-of-view FOV3. A substantially transparent cover glass 26 can be positioned between object 25 and optoelectronic module 09. Light source 10 emits light 27 such that at least a portion of light 27 is transmitted through the first region 13 and through cover glass 26. In some cases, first region 13 can be configured to transmit light 27 in the form of a single high-contrast geometric feature (such as a dot), or a pattern of high-contrast features, for example, a discrete array of illuminated dots, lines, or other shapes, or combinations of the aforementioned. Alternatively, in other cases, the first region 13 can be configured to transmit light 27 in the form of a homogenous (e.g., non-patterned/non-discrete) illumination.

Emitted light 27 impinges on and reflects off of the object 25, generating reflected light 28. Reflected light 28 is transmitted through the cover glass 26, the third region 16, and first filter 18 and then impinges on first detector 19. In some cases spurious reflections of light 27 from the host device cover glass may occur. Accordingly, spacer structure 21 may include a baffle-type structure 29 to block spurious reflections or limit the FOV of the third region 16. In some cases, proximity between optoelectronic module 09 and object 25 can be determined by a known relationship between detected radiation intensity (as detected by first detector 19) and distance to an object. Further, in other cases, proximity data acquisition can be acquired via triangulation techniques. Still further, in still other cases, proximity data acquisition can be acquired via time-of-flight techniques. For any of the aforementioned techniques, the determination of proximity can be implemented via additional processing circuitry/electronics 31, lookup table and/or via a host device (i.e., the device in which optoelectronic module 09 is installed).

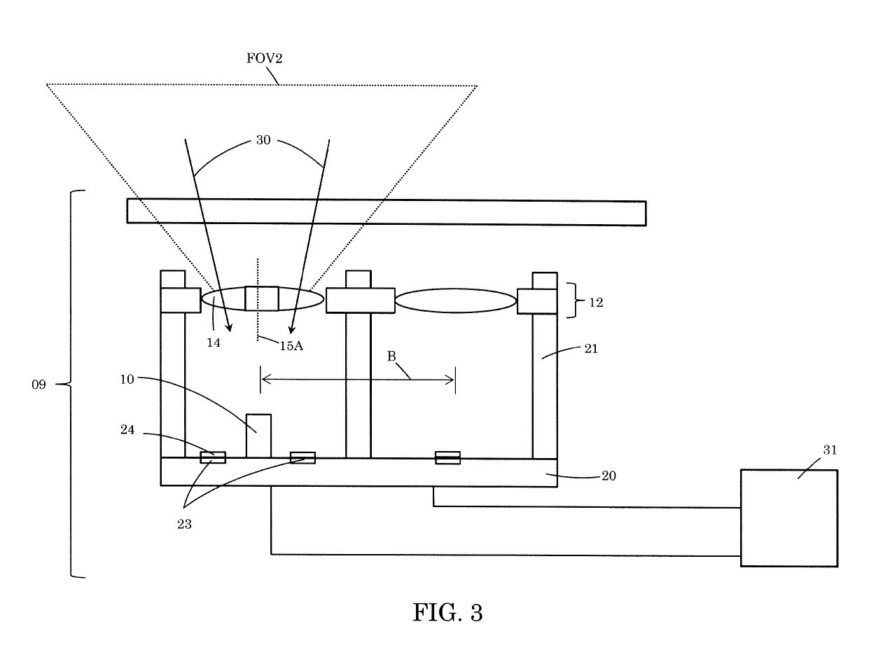

FIG. 3 depicts a side view of an example implementation of an optoelectronic module for spectral and proximity data acquisition operating in spectral sensing mode. Incident ambient light 30 (e.g., ambient light) is conveyed to second filter 24 via the second region 14 of the hybrid optical assembly 12. Wavelengths of ambient light 30 pass through second filter 24 and impinge on second detector 23. Signals associated with ambient light 30 (e.g., the spectral composition of ambient light) are read and processed via external processing circuitry 31 in some cases, while in other implementations a substantial amount of processing may occur on the sensor level. Accordingly, ambient light 30, and/or spectral components thereof, can be evaluated, e.g., for red, green, blue wavelength intensities.

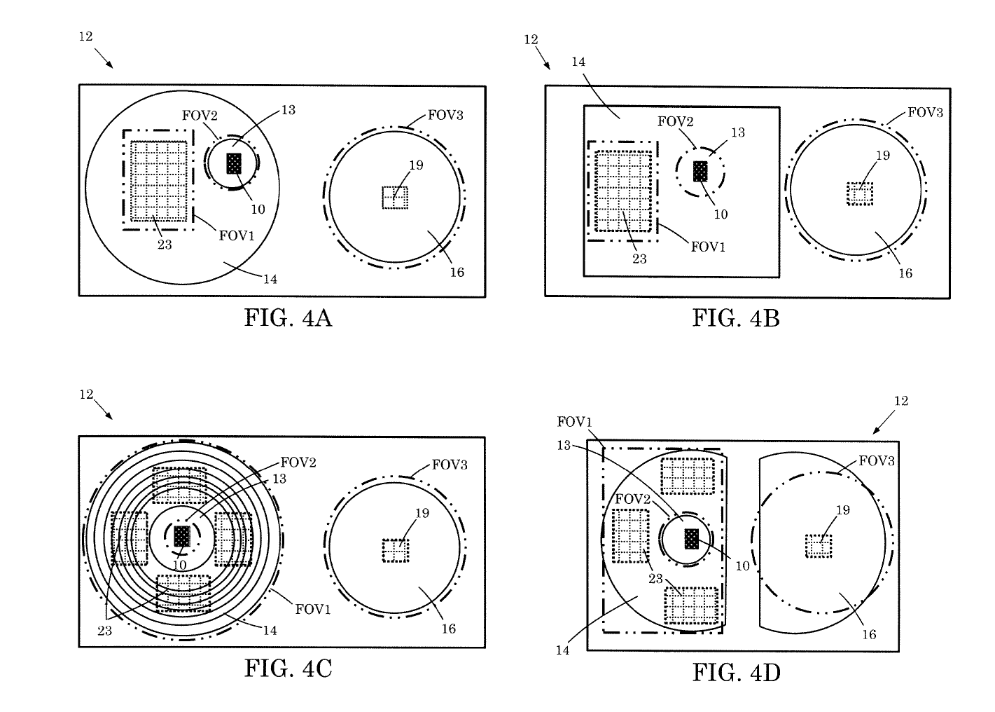

FIG. 4A depicts a plan view of an example implementation of a hybrid optical assembly with circular refractive optical regions. The first region 13 is aligned with the light source 10. The second region 14 is aligned with the second detector 23, and the third region 16 is aligned with the first detector 19. In this example, the optical axis of the first region 13 is parallel with the optical axis of the second region 14, but not coaxial.

FIG. 4B depicts a plan view of an example implementation of a hybrid optical assembly with circular and non-circular regions. In this example, the first region 13 and the second region 14 (the first and second regions) are optically contiguous; that is, the first region 13 and the second region 14 are not optically distinct regions of the hybrid optical assembly 12. In this example, the hybrid optical assembly 12 is composed of a transparent region with no optical function (e.g., focusing power) (i.e., the first region 13 and second region 14 are optically contiguous). Thus, each first region 13 and second region 14 are not characterized by optically distinct regions of the hybrid optical assembly 12, but instead are characterized by optically indistinct regions of the hybrid optical assembly 12. In this example, the field-of-view of the first region 13 is defined by the spatial divergence of the light source 10, depicted in FIG. 4B as the dash-dotted line FOV2. Further, the field of view of the second detector 23, depicted in FIG. 4B as the dash-dotted line FOV1 is defined by the lateral dimensions of the second detector 23 and, in some cases, the baffle structure 29.

FIG. 4C depicts a plan view of an example implementation of a hybrid optical assembly with circular, diffractive and refractive optical regions. The first region 13 is a circular, refractive optical region and is aligned with the light source 10. The second region 14 is a circular, diffractive optical region and is aligned with the second detector 23. The third region 16 is a circular, refractive optical region and is aligned with the first detector 19. In this example, the optical axis of the first region 13 is coaxial with the optical axis of the second region 14.

FIG. 4D depicts a plan view of an example implementation of a hybrid optical assembly with non-circular and circular (e.g., partially flat-sided) refractive optical regions. The first region 13 is a non-circular, refractive optical region and is aligned with the light source 10. The second region 14 is a circular, refractive optical region and is aligned with the second detector 23. The third region 16 is a non-circular, refractive optical region and is aligned with the first detector 19. In this example, the optical axis of the first region 13 is coaxial with the optical axis of the second region 14.

The example implementations depicted in FIGS. 4A-4D are intended to be non-limiting. Alternate implementations of hybrid optical assembly 12, or other variations or modifications are within the scope of this disclosure. Further, hybrid optical assembly 12 is not limited to regions 13, 14 and 16 of single lens elements. For example, each of the regions 13, 14 and 16 can be composed of a stack of two lens elements, or even three or more. Still further, although the first region 13 and second region 14 are depicted in FIGS. 4A-D as a contiguous arrangement of first and second regions, the first and second regions 13, 14 need not be contiguous. That is, they can be composed of discrete lens elements spatially separated from each other by an intervening component such as a stop, an aperture, and/or a lens barrel.

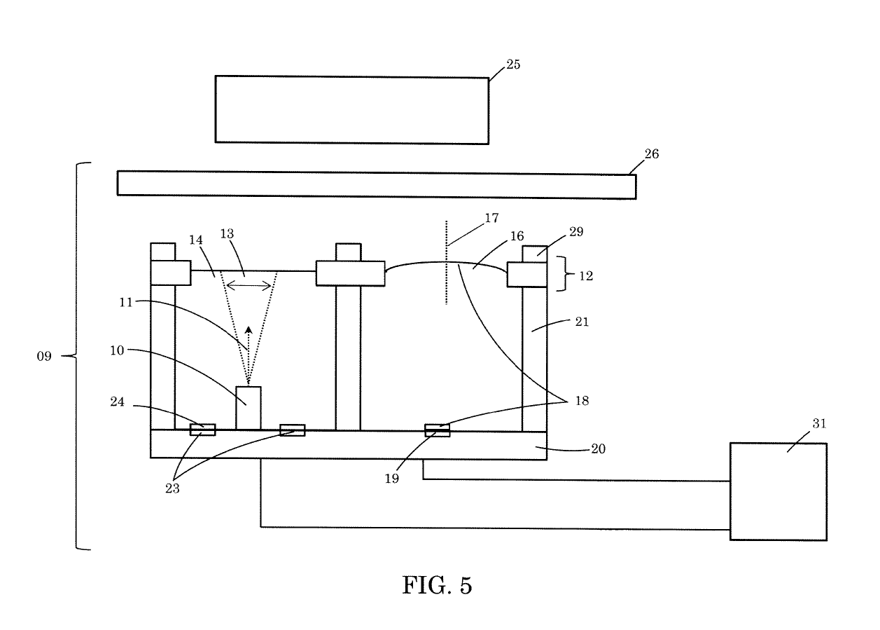

FIG. 5 depicts a side view of another example implementation of an optoelectronic module for spectral and proximity data acquisition where a hybrid optical assembly is implemented as an overmold. In this example, the first region 13, the second region 14 and the third region 16 are implemented as overmolds. That is, a polymeric material encases the light source 10, the second detector 23 and the first detector 19. The overmold may protect the light source 10, the second detector 23 and the first detector 19 from mechanical damage, for example. Further, the polymeric material can be formed/shaped into the hybrid optical assembly 12. That is, the overmold may take on the form of the first region 13, the second region 14 and the third region 16. For example, the overmold may take on the form of refractive lenses where each lens respectively establishes the first region 13, the second region 14 and the third region 16. Further, hybrid optical assembly can be implemented as a combination of separately formed optical elements and an overmold. That is, an overmold can form the base of the hybrid optical assembly 12, while separate optical elements forming the first region 13, the second region 14 and the third region 16, respectively, can be placed/positioned on/within the overmold.

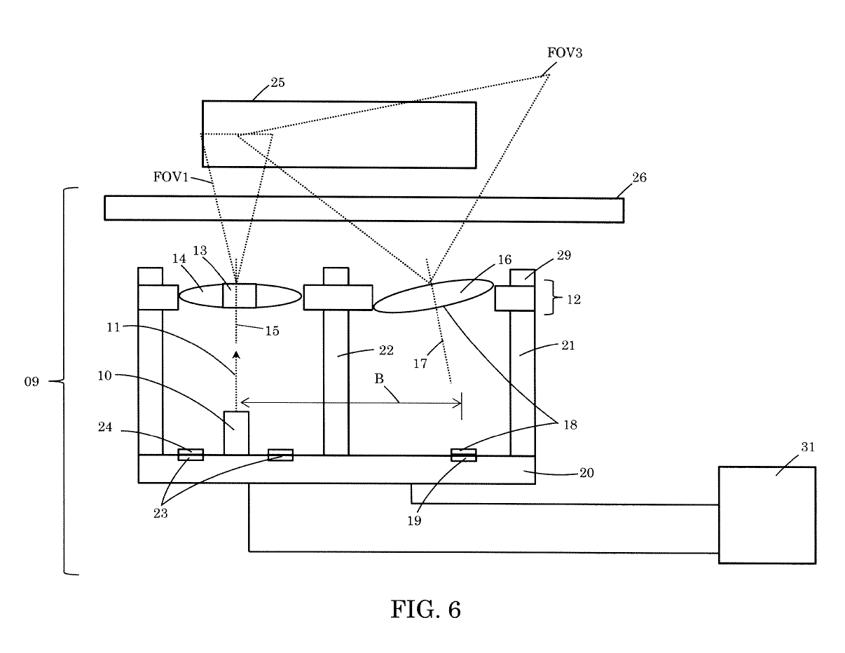

FIG. 6 depicts a side view of another example implementation of an optoelectronic module for spectral and proximity data acquisition where a region of the hybrid optical assembly is tilted. In this example, the third region 16 is tilted. That is, the third optical axis 17 is not perpendicular to the substrate 20. Moreover, the field-of-view FOV3 of the third region 16 is also tilted. In some implementations, the third region 16 can be titled so that the field-of-view FOV3 of the third region 16 overlaps the field of view of the field-of-view FOV1 of the first region 13. In some cases, tilting the third region 16 may permit proximity measurements at closer distances; e.g., 0 mm to 1 mm.

The various implementation of the optoelectronic modules described in the above examples may further include, processors, other electrical components or circuit elements (e.g., transistors, resistors, capacitive and inductive elements) pertinent to the function of the optoelectronic modules and apparent to a person of ordinary skill in the art. Moreover, although the present invention has been described in detail with respect to various implementations described above, other implementations including combinations or subtractions of various described features above, are also possible. Therefore, the spirit and scope of the appended claims is not limited to the foregoing implementations. That is, other implementations are within the scope of the claims.

1. An optoelectronic module comprising:
a substrate on which are integrated a light source operable to emit light at a particular one or more wavelengths with respect to an emission axis, a first detector operable to detect light at one or more wavelengths, and a second detector operable to detect light at one or more wavelengths;
a spacer structure laterally surrounding the light source, the second detector and the first detector, wherein the spacer structure is composed of a material that is non-transparent to the particular one or more wavelengths of light emitted by the light source or detectable by the second detector or first detector;
an inner wall isolating the first detector from the light source, wherein the inner wall is composed of a material that is non-transparent to the particular one or more wavelengths of light emitted by the light source or detectable by the second detector or the first detector; and
a hybrid optical assembly laterally surrounded by the spacer structure, the hybrid optical assembly including a first region characterized by a first field-of-view and a first optical axis, and a second region characterized by a second field-of-view and a second optical axis, and a third region characterized by a third field-of-view and a third optical axis, wherein the first region is aligned with the light source, the second region is aligned with the second detector, and the third region is aligned with the first detector.

2. The optoelectronic module of claim 1 further comprising:
a first filter aligned with the first detector, wherein the first filter is transparent to the one or more wavelengths of light emitted by the light source; and
a second filter aligned with the second detector, wherein the second filter is non-transparent to the one or more wavelengths of light emitted by the light source.

3. The optoelectronic module of claim 1, further comprising:
a baffle structure composed of a material that is non-transparent to a particular one or wavelengths of light emitted by the light source or detectable by the second detector or the first detector.

4. The optoelectronic module of claim 1, in which the emission axis is substantially perpendicular to the substrate.

5. The optoelectronic module of claim 1, in which the first optical axis is substantially perpendicular to the substrate.

6. The optoelectronic module of claim 1, in which the emission axis is substantially coaxial with the first optical axis.

7. The optoelectronic module of claim 1, in which the first field-of-view is between 10° and 20°.

8. The optoelectronic module of claim 1, in which the first field-of-view is between 5° and 10°.

9. The optoelectronic module of claim 1, in which the first field-of-view is between 1° and 3°.

10. The optoelectronic module of claim 1, in which the second field-of-view is between 60° and 180°.

11. The optoelectronic module of claim 1, in which the light source emits light with wavelengths corresponding to infrared light.

12. The optoelectronic module of claim 1, in which the light source is a vertical-cavity surface-emitting laser.

13. The optoelectronic module of claim 1, in which the light source is operable to emit modulated light.

14. The optoelectronic module of claim 1, in which the hybrid optical assembly comprises an overmold that encases the second detector, the first detector and the light source.

15. The optoelectronic module of claim 1, in which the third optical axis is substantially perpendicular to the substrate.

16. The optoelectronic module of claim 1, in which the third optical axis is tilted with respect to the substrate such that the first field-of-view of the first region partially overlaps the third field-of-view of the third region.

17. The optoelectronic module of claim 1, in which the first field-of-view and third field-of-view partially overlap.
